(19) United States
(12) Patent Application Publication
(10) Pub. No.: US 2005/0226455 A1
(43) Pub. Date: Oct. 13, 2005

(54) Display comprising and integrated loudspeaker and method for recognizing the touching of the display

(76) Inventors: Roland Aubauer, Munchen (DE); Gerhard Bock, Gauting (DE); Michael Hulskemper, Hunxe (DE); Stefano Ambrosius Klinke, Kerpen (DE); Frank Lorenz, Bocholt (DE); Ulf Niemeyer, Sprockhovel (DE); Christoph Porschmann, Gladbeck (DE)

Correspondence Address: BELL, BOYD & LLOYD, LLC, P. O. BOX 1135, CHICAGO, IL, 60690-1135, US

(21) Appl. No.: 10/514,280

(22) PCT Filed: Apr. 30, 2003
(86) PCT No.: PCT/DE03/01396

§ 371 Date: Nov. 2, 2004

(30) Foreign Application Priority Data
May 2, 2002 (DE) 102 19 641.9

(51) Int. Cl. H04R 25/00

(52) U.S. Cl. 381/388

(57) ABSTRACT

A combination is provided which consists of a loudspeaker and a display in which at least a portion of a sound-emitting surface of the loudspeaker forms the display that is touch-sensitive, and at least one recognition part is provided for recognizing the touching of the display.

### BACKGROUND OF THE INVENTION

A large number of electronic devices, such as mobile telephones or personal digital assistants, for example, have both a display for the visual representation of information and a loudspeaker for the audible reproduction of information. As a result of the continuing advances in the levels of miniaturization of such types of electronic devices, thought has been given for some time with regard to integrating components of the man/machine interface.

The developments in this direction have, in the meantime, progressed to the point where displays, in particular a liquid crystal display (LCD), are integrated with loudspeakers; at least in a prototype stage. Integrated displays and loudspeakers are suitable above all for use in mobile telephones or, generally, in communication devices which include an optical and acoustic component in the man/machine interface and at the same time exhibit small dimensions.

The advantage of integrating display and loudspeaker consists not only in the space saving aspect but also in reduced costs. Instead of two components, only one single component is required, even if it is more complex. This facilitates the production of electronic devices in which these components are used.

With regard to the majority of display/loudspeaker arrangements, at least one part of a sound-emitting surface is used as the display. Such loudspeakers are also referred to as display loudspeakers. Typically, with regard to such integrated systems, the display cover consisting of a transparent plastic, which is intended to protect the actual display against impact and scratching, also forms the sound-emitting surface (“membrane”) of the loudspeaker.

A loudspeaker is known from GB 2360901 A in which an electronic display is used as the membrane. This loudspeaker is intended first and foremost for use with portable electronic devices. In particular, mobile telephones are mentioned as a field of application. In spite of the savings in terms of components resulting from this combination of loudspeaker and display, certain components of the man/machine interface of an electronic device are still required such as a keypad or a microphone in the case of a mobile telephone, for example.

An object of the present invention is to improve an integrated display/loudspeaker arrangement to the effect that a further saving of components in the man/machine interface can be attained.

### SUMMARY OF THE INVENTION

One concept of the present invention consists in the fact that the display combined with a loudspeaker can be implemented as a touch-screen or touch-sensitive display. As a result, the display can be used for data input. The touch-sensitive display can take over at least a part of the functionality of a keypad. As a result, savings can be made in keypad components which, as a rule, are expensive and complex with respect to production engineering. According to a further embodiment of the present invention, savings are additionally made, at least in part, in components which are required for a touch-sensitive display. This is particularly achieved according to the present invention by the fact that at least one part of the loudspeaker, in particular the at least one part of the sound-emitting surface of the loudspeaker which forms the display, forms a recognition part for tactile contact made with the display. Components of the loudspeaker are thus used both for the loudspeaker functionality and for the touch-sensitive display functionality. As a result of this multi-function capability, further components of the man/machine interface for an electronic device can be saved.

In concrete terms, the present invention relates to an integrated display/loudspeaker arrangement, wherein the display is touch-sensitive. In addition, at least one recognition part for tactile contacts with the display is provided.

As already mentioned, at least one part of the sound-emitting surface of the display which forms the loudspeaker can form a recognition part for tactile contact made with the display. In other words, the sound-emitting surface used for the touch-sensitive display simultaneously forms a recognition part for tactile contacts. For example, the sound-emitting surface can be used for forwarding pulses which are triggered by tactile contact with the display. The touch-sensitive display also can be used as a transmission part in order to convey tactile contacts made with the display to a further recognition part such as a sensor, for example. This further recognition part can then evaluate the transmitting “tactile contact.”

By preference, a recognition part for tactile contacts with the display is formed by at least one actuator of the loudspeaker and/or by at least one sensor; in particular, an acoustic or optical sensor. In the former case, at least one actuator of the loudspeaker has a dual function; namely, it acts not only as an actuator but also as a sensor. Components for the touch-sensitive display can be saved as a result. In the latter case, special sensors are used which form a recognition part for tactile contacts with the display.

Such types of actuators and sensors are preferably located in the vicinity of the edge or at the edge of the sound-emitting surface of the loudspeaker. In the case of acoustic sensors, this arrangement presents itself for a precise detection of a tactile contact. For example, small microphones can be used at the edge of the sound-emitting surface as acoustic sensors. These microphones can detect a tone emitted by the sound-emitting surface whose frequency lies in a range which is inaudible to human beings. If the display is now touched, for example, by a pen, then changes occur in the acoustic decoupling through the sound-emitting surface and thus in the emitted tone. These changes can be detected by the microphones.

In a preferred embodiment of the loudspeaker, at least one actuator and/or sensor is/are located beneath the at least one part of the sound-emitting surface of the loudspeaker which forms the display. This presents itself first and foremost in the situation when a piezo-electric element is used as the actuator or sensor, which, for example, detects mechanical influences on the display resulting from tactile contacts. At least one actuator or sensor also can be located as an alternative or as an addition on the at least one part of the sound-emitting surface of the loudspeaker which forms the display. For example, piezo-electric elements used as actuators or sensors can be located directly on the side of the sound-emitting surface facing away from the acoustically active side; in other words, beneath the sound-emitting surface.

In one embodiment, the at least one actuator includes at least one piezo-electric element and/or one electromagnetic converter. In order to drive the sound-emitting surface, both piezo-electric elements (piezo-loudspeaker) and electromagnetic converters (dynamic loudspeaker) can be used. For the loudspeaker functionality, these elements convert an electrical variable into a mechanical variable. Conversely, advantage also can be taken of the fact that these elements are also capable of converting mechanical variables into electrical variables. This functionality can be utilized for the detection of tactile contacts with the display. If separate sensors are used for the detection of tactile contacts with the display, then piezo-electric elements are preferred. Such types of sensors can have very small dimensions and are therefore well-suited for integration into a loudspeaker.

Finally, with regard to the loudspeaker according to the present invention, evaluation parts also can be provided for evaluating the signal delivered by at least one actuator and/or at least one sensor. These evaluation parts can, for example, be integrated in a chip which is connected to the at least one actuator and/or the at least one sensor in such a way that it receives signals from them.

The present invention also relates to a method for recognizing tactile contacts with the display which is touch-sensitive and integrated with a loudspeaker. In this case, at least one part of a sound-emitting surface forms the display. Tactile contacts with the display are recognized by a recognition part.

For example, a tactile contact with the display can be recognized through a changed decoupling of sound by way of the sound-emitting surface of the loudspeaker and/or through changes in the standing waves or reflections on the surface. Preferably, the changed output of sound and/or a standing wave and/or reflections is/are picked up by using at least one sensor; in particular, an acoustic or optical sensor. In this case, the changed decoupling of sound and a standing wave are picked up by way of an acoustic sensor, whereas reflections can be detected both acoustically and optically.

The loudspeaker preferably emits an audio signal which has a frequency outside the audible frequency range of sound waves. A tactile contact with the display can be recognized on the basis of changes in the audio signal output. The audio signal is preferably emitted together with audio signals whose frequencies lie in the range which is audible to human beings; in other words, it is superimposed on these. As a result of the fact that the audio signal has a frequency outside the audible frequency range, it is imperceptible to a human being and, thus, does not impair the acoustic quality of an electronic device in which the method according to the present invention is being used.

A tactile contact with the display also may be recognized by a reaction to at least one actuator in the loudspeaker; for example, through a mechanical movement of an electromagnetic converter in the loudspeaker or of a piezo-electric element for driving the loudspeaker when tactile contact is made with the display. Accordingly, the at least one actuator preferably converts the force acting as a result of the tactile contact with the displays into an electrical signal which then can be further processed for detection of the tactile contact.

In order to recognize the position of a tactile contact on the display, it is possible, for example, to evaluate the time difference between electrical signals from at least two actuators which detect the tactile contact. An impedance measurement and/or a differential level measurement using the level of at least two signals from different sensors and/or actuators and/or an attenuation measurement of sound waves emitted by the sound surface in order to determine the position of a tactile contact on the display is also possible. Finally, multiple-path propagations and/or reflections of wave propagations triggered by the tactile contact with the display can be evaluated on the surface. The results of these measurements and/or calculations, which can be performed as alternatives or collectively, can be used for the widest variety of control purposes. With regard to the evaluation of multiple-path propagations and/or reflections of sound waves emitted by the sound surface, a trained neural network is preferably used for signal processing, which enables a reliable recognition of the position of the tactile contact.

Additional features and advantages of the present invention are described in, and will be apparent from, the following Detailed Description of the Invention and the Figures.

### BRIEF DESCRIPTION OF THE FIGURES

FIG. 1 shows a first exemplary embodiment of an integrated display/loudspeaker arrangement, in which sensors are provided for recognizing tactile contacts with the display, in top view.

FIG. 2 shows the arrangement illustrated in FIG. 1 in cross-section.

FIG. 3 shows a second exemplary embodiment of an integrated display/loudspeaker arrangement, in which tactile contacts with the display are recognized through a reaction to actuators in the loudspeaker.

FIG. 4 shows a third exemplary embodiment of an integrated display/loudspeaker arrangement, in which sensors located beneath the sound-emitting surface of the loudspeaker are provided recognizing tactile contacts with the display.

### DETAILED DESCRIPTION OF THE INVENTION

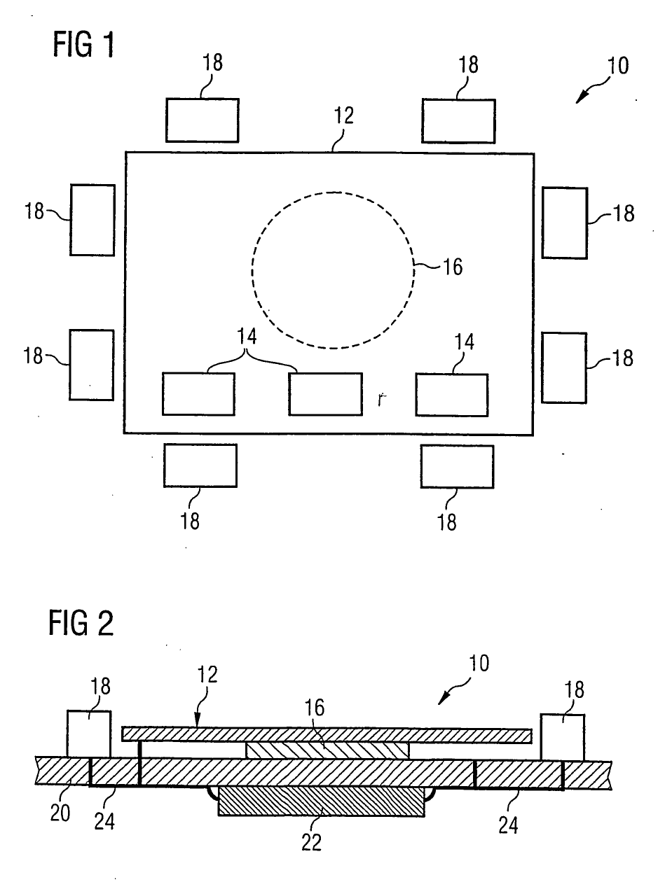

FIG. 1 shows a loudspeaker 10 with an integrated display. The loudspeaker 10 includes a sound surface 12 with the display. Symbols 14 are represented in order to visualize the display. These symbols can, for example, identify a certain function which is triggered by touching the display at the position occupied by the respective symbol. Typical functions can, for example, be simple functions such as display illumination “On/Off” and ring tone “On/Off,” a loud/quiet control using a +/− regulator, a so-called slider, a more complex menu control facility or even a virtual keypad.

By preference, an LCD is used for the display. The LCD simultaneously serves as an approximately flat sound-emitting surface for the loudspeaker 10. In order to drive the sound-emitting surface, or sound surface, 12, the loudspeaker 10 includes an actuator 16 which is located beneath the sound surface. More precisely, the actuator 16 is located on the side of the sound surface 12 which is facing away from the sound-emitting side. The actuator 16 can be a piezo-electric element or an electromagnetic converter; for example, a coil in a magnetic field as in the case of a dynamic loudspeaker.

Two sensors 18 are located at each edge side of the approximately square sound surface 12. Eight sensors 18 are provided in total. The sensors 18 preferably are small microphones which detect a tone which is emitted by the sound surface 12. This tone has a frequency which is outside the audible frequency range for a human being. If the sound surface with the display 12 is touched at a particular position, such as by use of a pen, then the decoupling of the tone through the sound surface changes. This is registered by the sensors 18.

In this way, it is possible to detect a tactile contact with the display and to recognize on the basis of the special arrangement of the sensors where approximately the contact took place on the display. If, for example, the symbol 14 in the lower left corner of the sound surface 12 bearing the display is touched by a user using a pen, then the decoupling of the tone in this area of the sound surface 12 is particularly strongly influenced, with the result that the sensors 18 located in the vicinity of this area deliver a particularly intensive recognition signal which can be processed accordingly by evaluation electronics connected downstream.

The loudspeaker with integrated display 10 illustrated in FIG. 1 is shown in cross-section in FIG. 2. The actuator 16 is located between the sound surface bearing the display 12 and a board 20 on which the loudspeaker 10 is mounted. On the board 20 are also mounted the sensors 18 and a chip 22. The chip 22 is used for evaluating the recognition signals generated by the sensors 18 and for driving the display in the sound surface 12. In other words, the chip 22 controls the input and output functionality of the display in the sound surface 12. To this end, the chip 22 is connected by way of electrical lines 24 on the board to the sensors 18 and to the display in the sound surface 12. The chip 22 preferably includes an integrated signal processing circuit, such as a signal processor or a neural network for processing the signals delivered by the sensors 18, and an LCD drive unit for the representation of symbols 14 on the display in the sound surface 12.

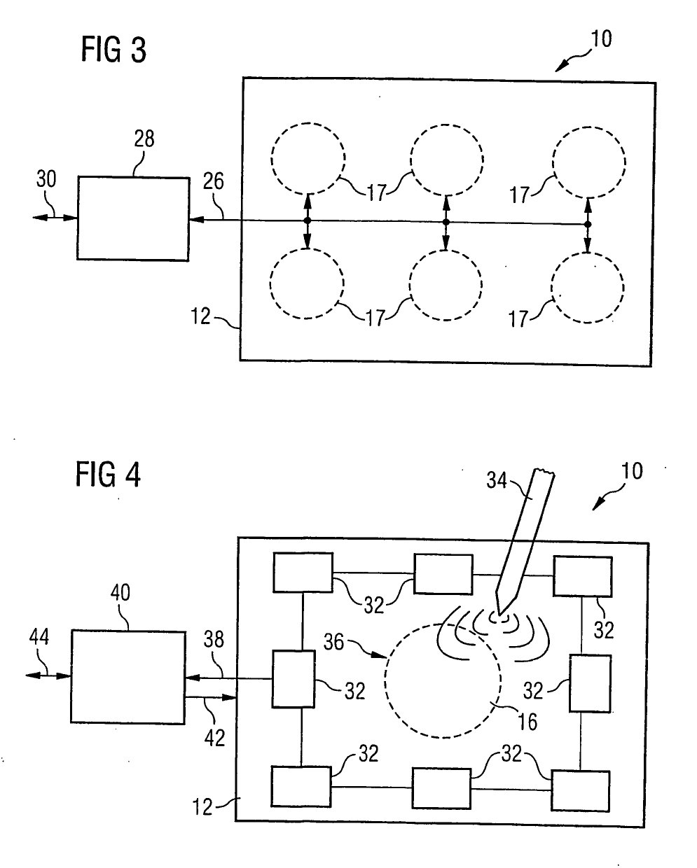

FIG. 3 shows a loudspeaker 10 with integrated display, in which actuators 17 are used which each include an integrated sensor. Actuators of this type can, for example, be conventional electromagnetic converters or piezo-electric elements for driving the sound surface of the loudspeaker. The electromagnetic converters or piezo-electric elements are, conversely, also used for the detection of a force acting on the display or sound surface and, thus, serve as sensors.

The actuators 17 are located with an approximately even distribution over the area which is covered by the sound surface 12 with display of the loudspeaker 10. As such, tactile contacts over the entire area used for the display can be detected. The resolution for detecting the position of a tactile contact on the display is influenced by the number of actuators. For detection with a medium resolution, a smaller number of actuators is sufficient (six, for example). As a result, a costly conventional touch-screen whose complexity is unnecessary for a large number of application instances can be saved.

An evaluation and control circuit is used for evaluating signals which are generated by the integrated sensors of the actuators 17; in particular, when a tactile contact is made with the display in the sound surface 12. In addition, control signals 26 are generated by the evaluation and control circuit 28, which are used for controlling the actuators 17 and, thus, for the output of sound by way of the sound surface 12. The evaluation and control circuit can be coupled by way of external signals 30 with further electronic components, such as in a mobile telephone or personal digital assistant, in which the loudspeaker 10 can be used.

FIG. 4 shows a loudspeaker 10 with integrated display in which an actuator 16 is located approximately centrally on the sound surface 12 with display; more precisely, beneath the sound surface 12 for driving the latter. In the edge zone beneath the sound surface 12, sensors 32 which are used for the detection of tactile contacts on the sound surface with display 12 likewise are located with an approximately even distribution. With regard to this embodiment, as in the case of the loudspeaker shown in FIGS. 1 and 2, separate actuators and sensors are used. A tactile contact on the display is indicated by the illustrated pen 34 which touches the bound surface 12 with display and thereby generates a wave 36. The wave can be detected by the sensors 32 which can be implemented as piezo-electric elements.

The sensor signals 38 delivered by the sensors 32 are routed to an evaluation and display control circuit 40. The evaluation and display control circuit 40 evaluates the sensor signals 38 delivered by the sensors 32 and controls the display in the sound surface 12 by way of display signals 42. The evaluation and display control circuit can be connected by way of external signals 44 to further electronic circuits; for example, for signal processing and/or controlling the display and/or loudspeaker.

Although the present invention has been described with reference to specific embodiments, those of skill in the art will recognize that changes may be made thereto without departing from the spirit and scope of the present invention as set forth in the hereafter appended claims.

1-16. (canceled)

17. A combination display/loudspeaker apparatus, comprising:
a touch-sensitive display; and
a loudspeaker, wherein at least one part of a sound-emitting surface of the loudspeaker forms the display, and wherein the loudspeaker includes at least one recognition part for tactile contacts made with the display.

18. A combination display/loudspeaker apparatus as claimed in claim 17, wherein at least one part of the at least one part of the sound-emitting surface of the loudspeaker which forms the display forms the at least one recognition part for tactile contacts made with the display.

19. A combination display/loudspeaker apparatus as claimed in claim 17, wherein the at least one recognition part for tactile contacts made with the display includes at least one of at least one actuator and at least one sensor, the at least one sensor being one of an acoustic sensor and an optical sensor.

20. A combination display/loudspeaker apparatus as claimed in claim 19, wherein the at least one of at least one actuator and at least one sensor is located at an edge of the sound-emitting surface of the loudspeaker.

21. A combination display/loudspeaker apparatus as claimed in claim 19, wherein the at least one of at least one actuator and at least one sensor is located proximate to an edge of the sound-emitting surface of the loudspeaker.

22. A combination display/loudspeaker apparatus as claimed in claim 19, wherein the at least one of at least one actuator and at least one sensor is located beneath the sound-emitting surface of the loudspeaker.

23. A combination display/loudspeaker apparatus as claimed in claim 19, wherein the at least one of at least one actuator and at least one sensor is located on the sound-emitting surface of the loudspeaker.

24. A combination display/loudspeaker apparatus as claimed in claim 19, wherein at least one of a plurality of actuators and a plurality of sensors are located in distributive fashion over an area covered by the sound-emitting surface of the loudspeaker.

25. A combination display/loudspeaker apparatus as claimed in claim 19, wherein the at least one actuator includes at least one of at least one piezo-electric element and one electromagnetic converter.

26. A combination display/loudspeaker apparatus as claimed in claim 19, wherein the at least one sensor includes at least one of at least one piezo-electric element and one electromagnetic converter.

27. A combination display/loudspeaker apparatus as claimed in claim 19, further comprising evaluation parts for evaluating signals delivered by the at least one of at least one actuator and at least one sensor.

28. A method for recognizing tactile contacts with a touch-sensitive display combined with a loudspeaker, the method comprising:
providing that at least one part of a sound-emitting surface of the loudspeaker form the display; and
recognizing tactile contacts made with the display via at least one recognition part.

29. A method for recognizing tactile contacts with a touch-sensitive display combined with a loudspeaker as claimed in claim 28, wherein the at least one recognition part recognizes a tactile contact with the display at least one of through a changed decoupling of sound via the sound-emitting surface of the loudspeaker and through at least one of at least one standing wave and reflections which are picked up using at least one sensor, the at least one sensor being one of an acoustic sensor and an optical sensor.

30. A method for recognizing tactile contacts with a touch-sensitive display combined with a loudspeaker as claimed in claim 28, the method further comprising:
emitting an audio signal, via the loudspeaker, having a frequency outside an audible frequency range of sound waves; and
detecting changes in the audio signal emitted to recognize a tactile contact with the display via the at least one recognition part.

31. A method for recognizing tactile contacts with a touch-sensitive display combined with a loudspeaker as claimed in claim 30, wherein the audio signal is emitted together with audio signals having frequencies in the audible frequency range of sound waves.

32. A method for recognizing tactile contacts with a touch-sensitive display combined with a loudspeaker as claimed in claim 28, wherein a tactile contact is recognized by a reaction to at least one actuator in the loudspeaker via the at least one recognition part.

33. A method for recognizing tactile contacts with a touch-sensitive display combined with a loudspeaker as claimed in claim 32, wherein the at least one actuator converts a force acting as a result of the tactile contact with the display into an electrical signal.

34. A method for recognizing tactile contacts with a touch-sensitive display combined with a loudspeaker as claimed in claim 33, wherein a position of a tactile contact on the display is recognized, via the at least one recognition part, by at least one of: evaluating the electrical signal from at least two actuators which detect the tactile contact and compare them with one another; an impedance measurement; a differential level measurement using a level of at least two signals from at least one of different sensors and different actuators; an attenuation measurement of sound waves emitted by the sound-emitting surface; and evaluating at least one of multiple-path propagations and reflections of waves propagating on the sound-emitting surface.
